(19) United States
(12) Patent Application Publication
(10) Pub. No.: US 2015/0176437 A1
(43) Pub. Date: Jun. 25, 2015

(54) CONTROLLING APPARATUS AND STARTING METHOD

(71) Applicant: KABUSHIKI KAISHA TOSHIBA, Minato-ku (JP)

(72) Inventors: Masayuki TOBO, Kawasaki (JP); Ba-Dai Cao, Kawasaki (JP); Akitaka Ishikawa, Koto (JP); Masaru Dejima, Yokohama (JP); Takahiro Mori, Yokohama (JP); Firman Bagja Juangsa, Kawasaki (JP); Manabu Hasegawa, Yokohama (JP)

(73) Assignee: KABUSHIKI KAISHA TOSHIBA, Minato-ku (JP)

(21) Appl. No.: 14/578,644

(22) Filed: Dec. 22, 2014

(30) Foreign Application Priority Data
Dec. 25, 2013 (JP) 2013-267527
Oct. 9, 2014 (JP) 2014-207870

(51) Int. Cl. F01K 23/10; F02C 7/26; F02C 9/00

(52) U.S. Cl. CPC F01K 23/101; F02C 9/00; F02C 7/26

(57) ABSTRACT

A controlling apparatus to control a combined cycle power-generating plant, the combined cycle power-generating plant including: a gas turbine; an heat recovery steam generator; and a steam turbine includes a controller that controls an output of the gas turbine. The controller controls the output of the gas turbine at a second output value that is greater than a first output value, after a paralleling of a power generator of the gas turbine, the first output value being a gas turbine output when an exhaust gas temperature of the gas turbine falls within a temperature range that is determined based on a metal temperature of the steam turbine. The controller controls the output of the gas turbine at the first output value, in a case where a temperature of the steam generated by the heat recovery steam generator exceeds a temperature based on the metal temperature.

### CROSS-REFERENCE TO RELATED APPLICATIONS

This application is based upon and claims the benefit of priority from Japanese Patent Application No. 2013-267527, filed Dec. 25, 2013 and Japanese Patent Application No. 2014-207870 filed Oct. 9, 2014; the entire contents of which are incorporated herein by reference.

### FIELD

Embodiments described herein relate generally to a controlling apparatus and a starting method.

### BACKGROUND

A combined cycle power-generating plant that is configured by the combination of a gas turbine, an heat recovery steam generator and a steam turbine is known. Here, the heat recovery steam generator recovers heat from the exhaust gas of the gas turbine, and generates steam. The steam turbine is driven by the steam generated by the heat recovery steam generator.

When the main steam temperature, which is the temperature of the steam generated by the heat recovery steam generator, rises to a predetermined temperature due to a great heat capacity of the heat recovery steam generator, there are a great time constant and a dead time. Even when the gas-turbine (GT) exhaust gas temperature and the GT exhaust gas flow rate rise with the increase in the output of the gas turbine, the main steam temperature does not readily rise. Therefore, even when the fuel supply is continued while the output of the gas turbine is kept at a predetermined output value, a long time that has an order of one hour to three hours in some cases is required before the main steam temperature rises to an intended temperature.

However, the thermal power generation is ranked as an emergence power supply, and therefore, a combined cycle power-generating plant having a quick start ability is demanded. When the quick start is performed in such a situation, the delay in the main steam temperature rise described above becomes a problem.

### BRIEF DESCRIPTION OF THE DRAWINGS

FIG. 1 is a schematic configuration diagram showing the configuration of a combined cycle power-generating plant 500 according to a first embodiment.

FIG. 2 is a schematic block diagram showing the configuration of the controlling apparatus 501 according to the first embodiment.

FIG. 3 is a cross unital view of the steam turbine 503 according to the first embodiment.

FIG. 4 is a flowchart showing the starting algorithm according to the first embodiment.

FIG. 5 is a starting chart of the starting method according to the first embodiment.

FIG. 6 is a graph showing an example of the relation between the output of the gas turbine 502 and the GT exhaust gas temperature.

FIG. 7 is an example of the starting chart when the starting method according to the first embodiment is used in the cold starting.

FIG. 8 is a flowchart showing a starting algorithm according to the second embodiment.

FIG. 9 is a starting chart of the starting method according to the second embodiment.

FIG. 10 is a schematic configuration diagram showing the configuration of a combined cycle power-generating plant 600 in a comparative example.

FIG. 11 similarly reduces the mismatch temperature, which may be said to be the key for starting.

FIG. 12 is a starting chart of the starting method according to the comparative example.

### DETAILED DESCRIPTION

According to one embodiment, a controlling apparatus is a controlling apparatus to control a combined cycle power-generating plant, the combined cycle power-generating plant including: a gas turbine; an heat recovery steam generator that recovers heat from exhaust gas of the gas turbine and generates steam; and a steam turbine that is driven by the steam generated by the heat recovery steam generator. The controlling apparatus includes a controller that controls an output of the gas turbine. The controller controls the output of the gas turbine at a second output value that is greater than a first output value, after paralleling (connecting) a power generator of the gas turbine to electric substation equipment, the first output value being a gas turbine output when an exhaust gas temperature of the gas turbine falls within a temperature range that is determined based on a metal temperature of the steam turbine. The controller controls the output of the gas turbine at the first output value, in a case where a temperature of the steam generated by the heat recovery steam generator exceeds a temperature based on the metal temperature.

### Comparative Example

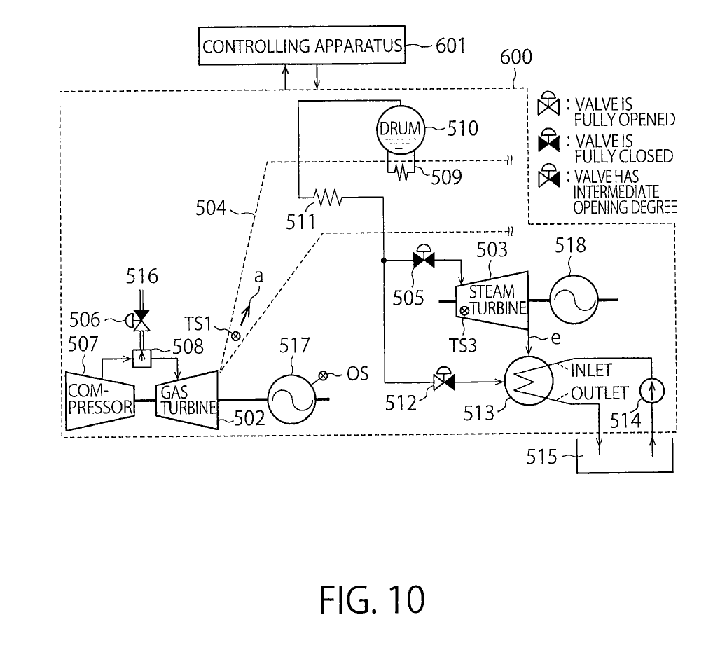

Before each embodiment is explained, a comparative example will be explained. FIG. 10 is a schematic configuration diagram showing the configuration of a combined cycle power-generating plant 600 in a comparative example.

In the combined cycle power-generating plant 600, a gas turbine 502 and a steam turbine 503 are multi-axially configured. A controlling apparatus 601 performs the overall operation and control of the combined cycle power-generating plant 600.

### (About Configuration of Combined Cycle Power-Generating Plant 600)

The combined cycle power-generating plant 600 includes a compressor 507, a gas turbine (GT) 502 that is connected with the compressor 507, and a GT power generator 517 whose rotation axis is connected with the gas turbine (GT) 502.

Further, the combined cycle power-generating plant 600 is provided with a combustor 508 that combusts fuel 516 with the air from the compressor 507. A high-temperature and high-pressure gas generated by the combustion of the fuel 516 is supplied from the combustor 508 to the gas turbine 502 so that the gas turbine 502 is driven.

In a pipe for supplying the fuel 516 to the combustor 508, a fuel regulating valve 506 that opens and closes based on a control signal from the controlling apparatus 601 is provided. By regulating the opening degree of the fuel regulating valve 506, it is possible to regulate the supply amount of the fuel 516 to the combustor 508.

Furthermore, the combined cycle power-generating plant 600 includes a GT output sensor OS that detects the output of the GT power generator 517 and supplies, to the controlling apparatus 601, a GT output signal indicating the output of the GT power generator 517.

Furthermore, the combined cycle power-generating plant 600 includes an exhaust gas temperature sensor TS1 that detects the temperature of a GT exhaust gas a exhausted from the gas turbine (GT) 502 and supplies, to the controlling apparatus 601, an exhaust gas temperature signal indicating the detected temperature of the GT exhaust gas a.

Furthermore, the combined cycle power-generating plant 600 includes an heat recovery steam generator 504 that recovers heat from the GT exhaust gas a of the gas turbine 502 and generates steam.

Furthermore, the combined cycle power-generating plant 600 includes an evaporator 509 that recovers heat from the GT exhaust gas a, a drum 510 that is connected with the evaporator 509, and a superheater 511 whose steam input port is connected with a steam exhaust port of the drum 510 through a pipe.

Furthermore, the combined cycle power-generating plant 600 includes a controlling valve 505 whose steam input port is connected with a steam exhaust port of the superheater 511 through a pipe.

Furthermore, the combined cycle power-generating plant 600 includes a steam turbine 503 whose steam input port is connected with a steam exhaust port of the controlling valve 505 through a pipe, and an ST power generator 518 whose rotation axis is connected with a rotation axis of the steam turbine 503.

Furthermore, the combined cycle power-generating plant 600 includes a turbine bypass regulating valve 512 whose steam input port is connected with a steam exhaust port of the superheater 511 through a pipe. The turbine bypass regulating valve 512 leads the steam bypassing the steam turbine, to a steam condenser 513 described later.

Furthermore, the combined cycle power-generating plant 600 includes the steam condenser 513 whose steam input port is connected with a steam exhaust port of the turbine bypass regulating valve 512 through a pipe, whose exhaust input port is connected with an exhaust port of the steam turbine 503 through a pipe, and that performs the heat exchange between the water going out of an outlet and seawater. An exhaust steam e exhausted from the steam turbine 503 flows in the steam condenser 513. The steam condenser 513 cools the exhaust steam e exhausted from the steam turbine, with seawater or air.

For example, the steam condenser 513 cools the exhaust steam e, using the seawater supplied by a circulating water pump 514.

### (About Operation of Combined Cycle Power-Generating Plant 600)

Next, the operation of the combined cycle power-generating plant 600 will be explained. FIG. 10 shows an operation state of the combined cycle power-generating plant 600 in a state in which the controlling valve 505 is fully closed after the ignition operation of the gas turbine 502 is performed. Here, as an example, the fuel regulating valve 506 has an intermediate opening degree, and the turbine bypass regulating valve 512 has an intermediate opening degree.

The fuel 516 for the gas turbine 502 is put in from the fuel regulating valve 506, and is combusted in the combustor 508, with the air from the compressor 507. The GT exhaust gas with a high temperature flows in the heat recovery steam generator 504, the heat recovery is performed in the evaporator 509, and steam is generated in the drum 510. The generated steam is further superheated in the superheater 511, by the heat exchange with the GT exhaust gas a, and becomes main steam b.

However, the controlling valve 505 of the steam turbine 503 remains fully closed, and the starting of the steam turbine 503 is not yet begun. This is because, when a time does not elapse from the ignition, the temperature of the main steam b is insufficient and it is not permitted to open the controlling valve 505 and put it in the steam turbine 503 (this is referred to as a steam passing).

Until the steam passing is permitted, the turbine bypass regulating valve 512 performs the valve opening while performing the pressure control of the main steam b from the superheater 511, and thereby, leads it to the steam condenser 513. The seawater 515 pumped by the circulating water pump 514 is supplied to the steam condenser 513, and the main steam b having passed through the turbine bypass regulating valve 512 is cooled in the steam condenser 513, by the seawater 515. As a result, the main steam b condenses and becomes condensate, and on the other hand, the seawater 515 is returned to the sea, with the temperature rise by the heat exchange.

### Process of Controlling Apparatus 601 in Comparative Example

A main steam temperature matching control to be executed by the controlling apparatus 601 according to the comparative example is a control of calculating a gas-turbine exhaust gas temperature target value described later and increasing or decreasing the gas turbine output (load), for the purpose of suppressing the thermal stress to be generated in the steam turbine 503. For example, the uniaxial combined cycle power-generating plant 600 increases the inlet-guide-vane opening degree of the gas turbine 502 at the no-load rated-speed operation, decreases the GT exhaust gas temperature, and reduces the mismatch temperature.

Here, the mismatch temperature is a temperature deviation that is given by the definition of the following Formula (1).

Mismatch Temperature=Main Steam Temperature−First-Stage-Shell Inner Surface Metal Temperature of Steam Turbine (1)

Here, the first-stage-shell inner surface metal temperature is a temperature that varies for each starting, and the temperature tends to become lower as the elapsed time from the last starting becomes longer. The first-stage-shell inner surface metal temperature can vary in a range of 150 degrees to 550 degrees, for example.

The inlet-guide-vane opening degree is the opening degree of an inlet guide vane that regulates the amount of the air in the gas turbine. When the inlet-guide-vane opening degree is increased, more air flows in the gas turbine 502 with respect to the same fuel, and therefore, the GT exhaust gas temperature decreases. Thus, by regulating the inlet-guide-vane opening degree, it is possible to regulate the GT exhaust gas temperature in a certain extent of range.

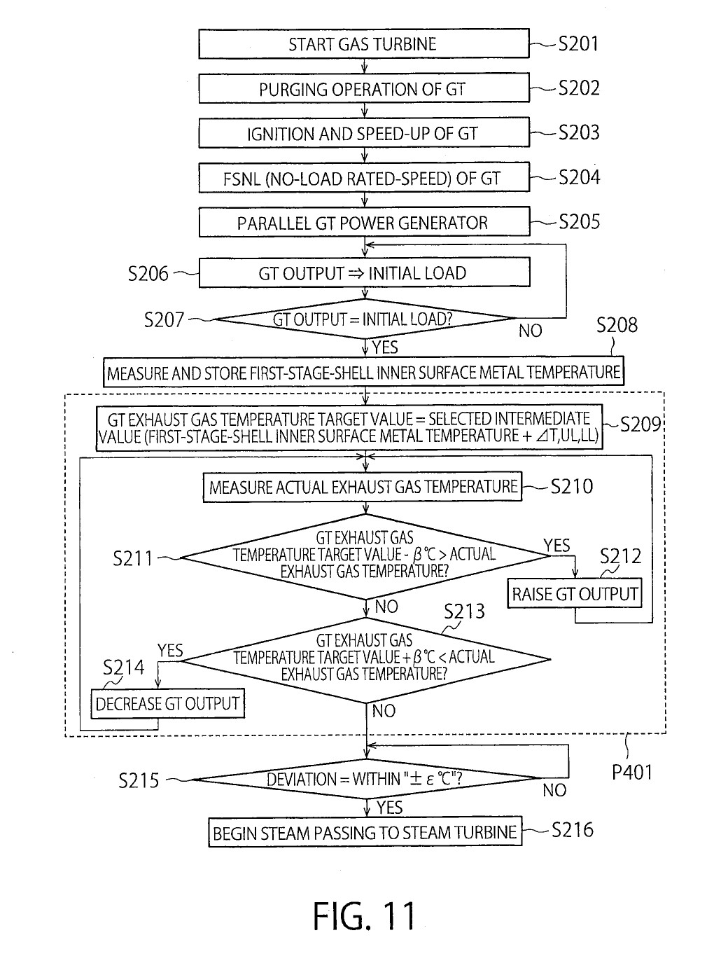

A main steam temperature matching control process P401 in the comparative example of FIG. 11 similarly reduces the mismatch temperature, which may be said to be the key for starting. In the main steam temperature matching control process P401, the gas turbine 502 performs a load operation of supplying and combusting more fuel 516, for the black starting of the multi-axial steam turbine 503. By such an action that the gas turbine output at the time of the load operation is increased or decreased, the mismatch temperature is lessened. Here, the multi-axial steam turbine 503 requires a larger amount of main steam b than a uniaxial combined steam turbine.

Then, the main steam temperature and the GT exhaust gas temperature have a correlation of the following Formula (2). Here, this excludes a transition period with a gas turbine output fluctuation, and is a relational expression that holds in a steady state.

Main Steam Temperature=GT Exhaust Gas Temperature−ΔT(° C.) (2)

Here, “ΔT (° C.)” is a value that is determined for each combined cycle power-generating plant based on the heat transfer condition in the heat recovery steam generator design, and is typically a value of about 20° C. to about 60° C.

When Formula (2) is substituted into Formula (1) and the main steam temperature is eliminated, the following Formula (3) is obtained.

Mismatch Temperature=GT Exhaust Gas Temperature−ΔT−First-Stage-Shell Inner Surface Metal Temperaturea (3)

From the standpoint of thermal stress, the ideal steam turbine starting is to perform the steam passing when the mismatch temperature is zero (0° C.). Therefore, when 0 is substituted into the left-hand side of Formula (3) and the deformation is performed, the following Formula (4) is obtained.

GT Exhaust Gas Temperature=First-Stage-Shell Inner Surface Metal Temperature+ΔT (4)

In accordance with this relation, the controlling apparatus 601 calculates the gas-turbine exhaust gas temperature target value, as the following Formula (5).

GT Exhaust Gas Temperature Target Value=First-Stage-Shell Inner Surface Metal Temperature+ΔT (5)

### Starting Method According to Comparative Example

A starting method of the combined cycle power-generating plant 600 according to the comparative example will be described with a starting algorithm in FIG. 11. FIG. 11 is a flowchart showing a starting algorithm according to the comparative example.

Firstly, the gas turbine 502 is started (step S201). Then, first, the purging operation is performed (step S202), and after the stages of the ignition and speed-up (step S203), the no-load rated-speed operation is reached (step S204). Thereafter, paralleling (connecting) the GT power generator 517 to electric substation equipment is performed (step S205). Therewith, for avoiding the disturbance of reverse power, the gas turbine 502 is instantly controlled such that the load rises to the initial load in a step manner (steps S206 and S207).

In the case of reaching the initial load (YES in step S207), the controlling apparatus 601 according to the comparative example measures the first-stage-shell inner surface metal temperature and stores it (step S208).

In FIG. 11, the main steam temperature matching control process P401 is begun, shortly after the load of the gas turbine 502 has risen to the initial load. First, the controlling apparatus 601 according to the comparative example, using the stored first-stage-shell inner surface metal temperature, calculates the GT exhaust gas temperature target value (=first-stage-shell inner surface metal temperature+ΔT), based on the relation of Formula (5). However, the gas turbine 502 cannot be operated at an extremely low or high exhaust gas temperature, and therefore, a restriction by a lower limit value (LL value) and an upper limit value (UL value) is provided. Specifically, the controlling apparatus 601 selects an intermediate value of “first-stage-shell inner surface metal temperature+ΔT”, “LL value” and “UL value”, as the GT exhaust gas temperature target value, and realizes this (step S209).

Then, the controlling apparatus 601 measures an actual GT exhaust gas temperature at the current time point, and compares it with the GT exhaust gas temperature target value (step S211). If “GT exhaust gas temperature target value−β” is higher than the actual GT exhaust gas temperature (YES in step S211), the controlling apparatus 601 acts so as to raise the gas turbine output and raise the GT exhaust gas temperature (step S212). Here, “β” is a predetermined number.

On the other hand, if “GT exhaust gas temperature target value+β” is lower than the actual GT exhaust gas temperature (YES in step S213), the gas turbine output is decreased, and the GT exhaust gas temperature is decreased (step S214). By repeating this, the gas turbine output is regulated such that the actual GT exhaust gas temperature falls within an allowable deviation range (within “+/−β° C.”) of the GT exhaust gas temperature target value. Hereinafter, this gas turbine output is referred to as a “first output value c”.

When the fuel supply is continued while the first output value “c” is kept, the main steam temperature also rises gradually with a lapse of time, and asymptotically approximates the first-stage-shell inner surface metal temperature gradually. Whether the deviation between the first-stage-shell inner surface metal temperature and the main steam temperature is within “±ε” is judged (step S215). Then, when the deviation between the first-stage-shell inner surface metal temperature and the main steam temperature gets to be a sufficiently small allowable deviation (within “+/−ε° C.”) (YES in step S215), the controlling apparatus 601 opens the controlling valve 505, and begins the steam passing to the steam turbine 503. On the other hand, if the deviation is not within “±ε” (NO in step S215), the controlling apparatus 601 waits with no change.

Here, after the steam passing is begun, the speed-up of the steam turbine 503 and the output rise of the gas turbine 502/steam turbine 503 are continuously performed. However, these are not related to the present invention, and the detailed explanations are omitted. Eventually, the gas turbine 502 reaches the maximum output (base load) that is allowed under an atmospheric temperature condition at that time, and the steam turbine 503 also reaches the rated output, by the main steam b generated by the heat recovery of the GT exhaust gas a.

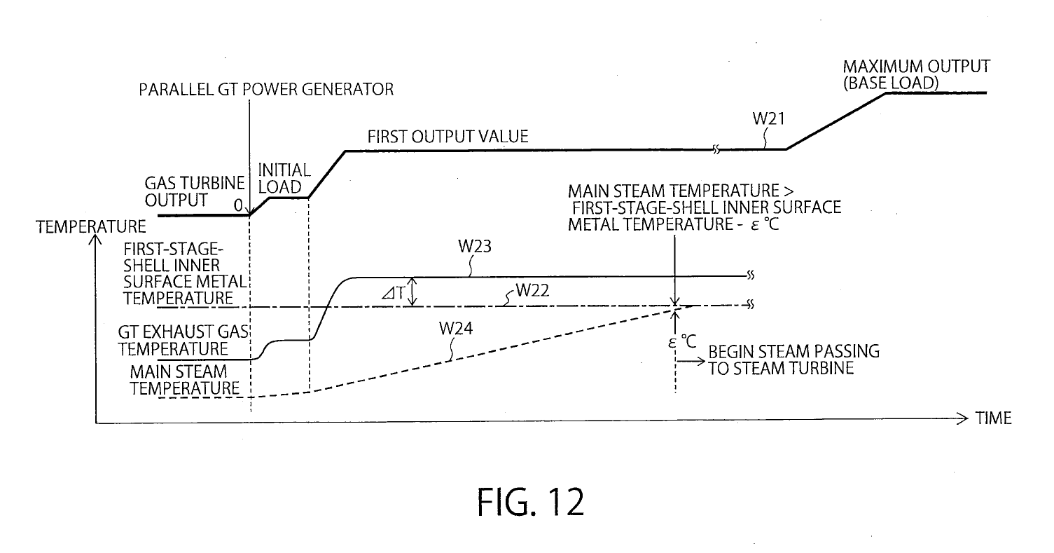

FIG. 12 is a starting chart of the starting method according to the comparative example. FIG. 12 shows temporal changes in the outputs of the respective sensors when the starting method according to the comparative example is executed. In FIG. 12, as shown by a waveform W21 that shows the temporal change in the gas turbine output, the gas turbine output, after the initial load, is constant at the first output value “c”. Thereby, as shown by a waveform W23 that shows the temporal change in the GT exhaust gas temperature, the GT exhaust gas temperature is also constant while the gas turbine output is the first output value “c”. As shown by a waveform W24 that shows the temporal change in the main steam temperature and a waveform W22 that shows the temporal change in the first-stage-shell inner surface metal temperature in FIG. 12, the main steam temperature of the combined cycle power-generating plant 600 according to the comparative example asymptotically rises to the first-stage-shell inner surface metal temperature slowly.

### (Supplement)

The difficulty due to the main steam temperature not rising in a short time is clearly shown by the method of the main steam temperature matching control. That is, the main steam temperature matching control, in which the GT exhaust gas temperature target value is calculated and the actual exhaust gas temperature is matched to it, is so to speak, a method of “indirectly” regulating the main steam temperature through the intermediary of the GT exhaust gas temperature. If the GT exhaust gas temperature is excluded and the main steam temperature matching control is changed into a control scheme of “directly” regulating the main steam temperature, the mechanism of the main steam temperature matching process P401 can be described as “the main steam temperature matching control measures an actual main steam temperature at the current time point, compares it with a main steam temperature target value, and if the actual steam temperature is lower, raises the gas turbine output to raise the main steam temperature”. However, the main steam temperature does not rapidly rise, and therefore, there is a problem in that, while waiting for it, the gas turbine output exceeds a proper value and rises to the maximum output (base load). For this reason, the method of “indirectly” regulating the main steam temperature through the intermediary of the GT exhaust gas temperature is adopted as the main steam temperature matching control.

### First Embodiment

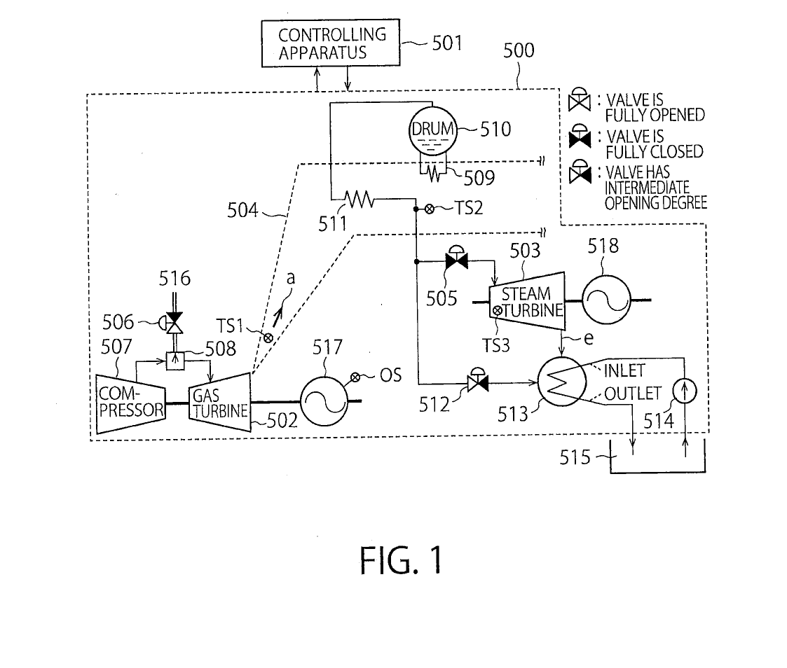

In the following, an embodiment of the present invention will be explained with reference to the drawings. FIG. 1 is a schematic configuration diagram showing the configuration of a combined cycle power-generating plant 500 according to a first embodiment.

In the configuration of the combined cycle power-generating plant 500 in FIG. 1, a main steam temperature sensor TS2 is added, relative to the configuration of the combined cycle power-generating plant 600 in FIG. 10. The main steam temperature sensor TS2 detects the temperature of a pipe linking a superheater 511 and the controlling valve 505, as the main steam temperature, and supplies a main steam temperature signal indicating the detected main steam temperature, to the controlling apparatus 501.

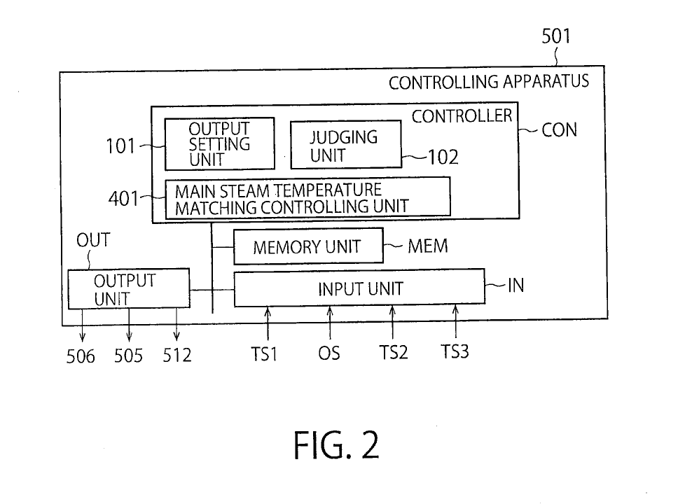

A controlling apparatus 501 performs the overall operation and control of the combined cycle power-generating plant 500. The configuration of the controlling apparatus 501 according to the first embodiment will be explained, using FIG. 2.

### (Configuration of Controlling Apparatus 501)

FIG. 2 is a schematic block diagram showing the configuration of the controlling apparatus 501 according to the first embodiment. As shown in FIG. 2, the controlling apparatus 501 includes a controller CON, a memory unit MEM, an input unit IN and an output unit OUT. The constituent elements are connected with each other through a bus.

The input unit IN receives sensor measurement signals measured by the respective sensors that are included in the combined cycle power-generating plant 500, and outputs the received sensor measurement signals to the controller CON.

Specifically, for example, the input unit IN receives an exhaust gas temperature signal from an exhaust gas temperature sensor TS1, and outputs the received exhaust gas temperature signal to the controller CON. Further, for example, the input unit IN receives a main steam temperature signal from a main steam temperature sensor TS2, and outputs the received main steam temperature signal to the controller CON. Further, for example, the input unit IN receives an inner surface metal temperature signal from an inner surface metal temperature sensor TS3, and outputs the received inner surface metal temperature signal to the controller CON.

Further, for example, the input unit IN receives a GT output signal from a GT output sensor OS, and outputs the received GT output signal to the controller CON.

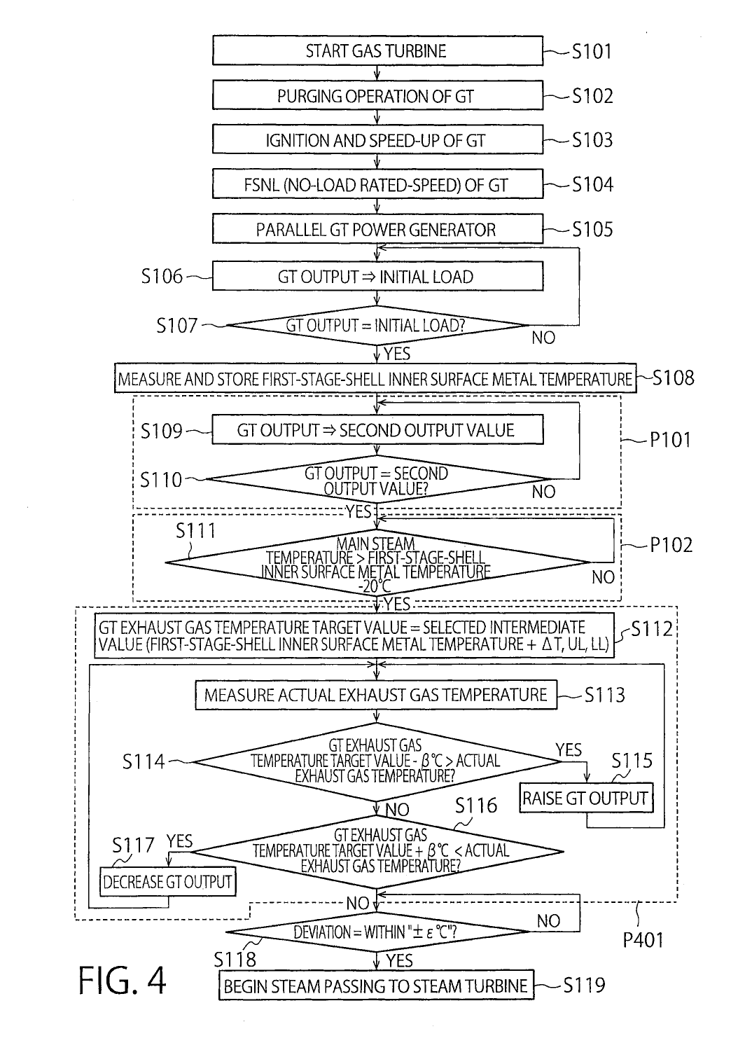

In the memory unit MEM, the software that is programmed in accordance with a starting algorithm shown by a later-described flowchart in FIG. 4 is stored.

The controller CON controls the combined cycle power-generating plant 500, by reading the software from the memory unit MEM and executing it.

As an example thereof, the controller CON controls the output of the gas turbine 502. On that occasion, the controller CON controls the fuel regulating valve 506, and thereby, regulates the supply amount of the fuel 516 to the gas turbine 502. Here, the opening and closing of the fuel regulating valve 506 and the output of the gas turbine 502 have a proportional relation, and therefore, the controller CON can control the output of the gas turbine 502 by controlling the fuel regulating valve 506.

Further, as another example, the controller CON controls the controlling valve 505 and the turbine bypass regulating valve 512.

Here, the controller CON includes an output setting unit 101, a judging unit 102 and a main steam temperature matching controller 401. The process of each unit of the controller CON will be described later.

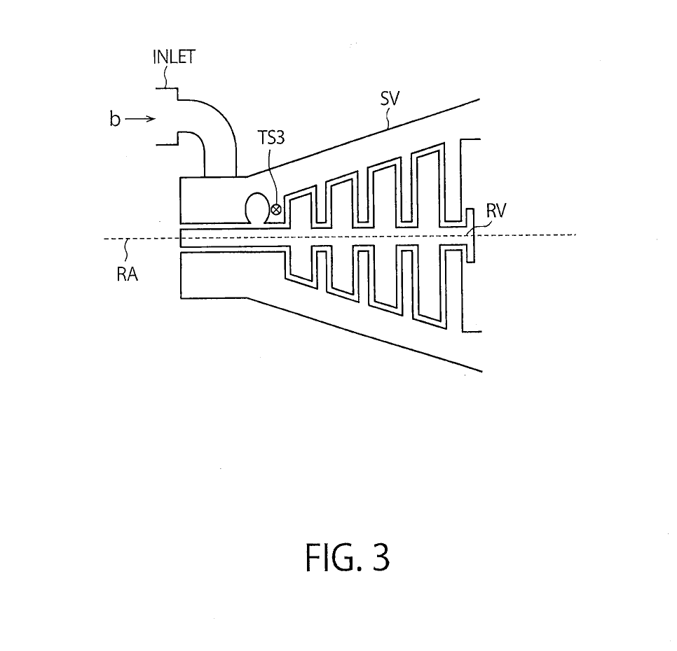

FIG. 3 is a cross unital view of the steam turbine 503 according to the first embodiment. This cross unital view shows a rotor vane RV that can rotate around a rotation axis RA, a stator vane SV that surrounds the rotor vane RV by the intermediary of a vacant space, and a steam inlet INLET into which the main steam b flows. In the case where the inner surface metal temperature sensor TS3 detects the first-stage-shell inner surface metal temperature, the inner surface metal temperature sensor TS3, which is provided, as an example, at the position shown in FIG. 3, detects the metal temperature of the stator vane SV.

### Starting Method According to First Embodiment

In the starting according to the first embodiment, an output setting process P101 and a judging process P102 in FIG. 4 are added, relative to the starting according to the above-described comparative example. In the following, a starting method according to the first embodiment will be explained.

By repeating a part of the plant starting method according to the above-described comparative example, the GT exhaust gas temperature target value for the main steam temperature matching control is calculated from the above Formula (5), depending on the first-stage-shell inner surface metal temperature.

GT Exhaust Gas Temperature Target Value=First-Stage-Shell Inner Surface Metal Temperature+ΔT (5)

Then, the gas turbine output before the steam passing to the steam turbine 503 is kept at an output value (“first output value” c) that gives the GT exhaust gas temperature in Formula (5). Then, the wait for the rise in the main steam temperature is performed here, and the steam passing is performed.

A starting process of the combined cycle power-generating plant 500 according to the first embodiment will be explained along the starting algorithm of FIG. 4. FIG. 4 is a flowchart showing the starting algorithm according to the first embodiment.

When the gas turbine 502 is started (step S101), first, the purging operation in which air is passed and staying fuel is exhausted is performed (step S102), and after the stages of the ignition and speed-up (step S103), the no-load rated-speed operation is reached (step S104). Thereafter, paralleling (connecting) the GT power generator 517 to electric substation equipment is performed (step S105). Then, the controller CON commands the measurement of the first-stage-shell inner surface metal temperature, and stores the first-stage-shell inner surface metal temperature obtained by the measurement, in the memory unit MEM. Shortly after that, for avoiding the disturbance of reverse power, the controller CON performs such a control that the gas turbine output increases in a step manner and reaches the initial load (steps S106 and S107).

In the case of reaching the initial load (YES in step S107), the controller CON of the controlling apparatus 501 measures the first-stage-shell inner surface metal temperature and stores it (step S108). The process described so far is the same as the starting algorithm according to the comparative example in FIG. 11.

For promoting a quicker rise in the main steam temperature after the gas turbine 502 reaches the initial load, the following output setting process P101 is newly provided in the starting algorithm of FIG. 4.

The output setting unit 101 executes the output setting process P101 in FIG. 4. Specifically, the output setting unit 101 raises the output of the gas turbine 502 such that it gets to be an output greater than the first output value “c” (this is referred to as a “second output value” d. The specific value will be described later.) (steps S109 and S110), and keeps that output. While being kept at the second output value “d”, the heat recovery steam generator 504 can take higher-temperature and more GT exhaust gas a and can perform an energetic heat recovery, so that the main steam temperature rises more rapidly.

Then, the wait for the rise in the main steam temperature is performed, and the switching from the second output value “d” to the first output value “c” is performed at a proper timing. From the standpoint of thermal stress, the ideal main steam temperature is equal to the first-stage-shell inner surface metal temperature, and therefore, as one scheme, the switching to the first output value “c” is performed when the main steam temperature has risen to the first-stage-shell inner surface metal temperature.

However, in the case where the switching is performed after the rise to that extent, the main steam temperature exceeds the first-stage-shell inner surface metal temperature that is the target, causing the so-called overshoot phenomenon. Hence, in the starting algorithm, the controller CON performs such a control that the switching from the second output value “d” to the first output value “c” is performed at a timing shortly before reaching the target temperature.

Specifically, the following judging process P102 is newly provided in the starting algorithm of FIG. 4. For example, the judging unit 102 judges whether the main steam temperature gets to be a temperature that is lower than the first-stage-shell inner surface metal temperature by a predetermined temperature (here, 20° C. as an example) (step S111). In the case where the main steam temperature gets to be a temperature that is lower than the first-stage-shell inner surface metal temperature by the predetermined temperature (here, 20° C. as an example) (YES in step S111), the main steam temperature matching controller 401 begins the process.

Subsequently, similarly to the comparative example, the main steam temperature matching controller 401 executes the main steam temperature matching process P401 in FIG. 4. Specifically, similarly to the comparative example, the main steam temperature matching controller 401 calculates the GT exhaust gas temperature target value (=first-stage-shell inner surface metal temperature+ΔT), based on the relation of Formula (5), using the stored first-stage-shell inner surface metal temperature. Similarly to the comparative example, the main steam temperature matching controller 401 provides a restriction by a lower limit value (LL value) and an upper limit value (UL value), and selects an intermediate value of “first-stage-shell inner surface metal temperature+ΔT”, “LL value” and “UL value”, as the GT exhaust gas temperature target value (step S112).

Then, the main steam temperature matching controller 401 measures, the actual GT exhaust gas temperature at the current time point (step S113), and compares it with the GT exhaust gas temperature target value (step S114). If “GT exhaust gas temperature target value−β” is higher than the actual GT exhaust gas temperature (YES in step S114), the main steam temperature matching controller 401 raises the gas turbine output (step S115).

On the other hand, if “GT exhaust gas temperature target value−β” is lower than the actual GT exhaust gas temperature (NO in step S114), the main steam temperature matching controller 401 decreases the gas turbine output (step S117). Here, since the actual GT exhaust gas temperature of the second output value “d” is a higher temperature than the GT exhaust gas temperature target value, in the starting method according to the first embodiment, the gas turbine output is necessarily decreased, and the gas turbine output is regulated to the first output value “c”, such that the actual GT exhaust gas temperature falls within the allowable deviation range (within “+/−β° C.”) of the GT exhaust gas temperature target value.

Since the gas turbine output is switched from the second output value “d” to the first output value “c” in this way, the main steam temperature, as a result, asymptotically approximates the first-stage-shell inner surface metal temperature, from the temperature that is lower by −20° C. relative to the first-stage-shell inner surface metal temperature as the target, and the deviation between the first-stage-shell inner surface metal temperature and the main steam temperature is reduced (within “+/−ε° C.” of the allowable deviation) in a remarkably short time, compared to the starting method according to the comparative example. Therefore, earlier than the comparative example, the controlling valve 505 is opened, and the steam passing to the steam turbine is begun.

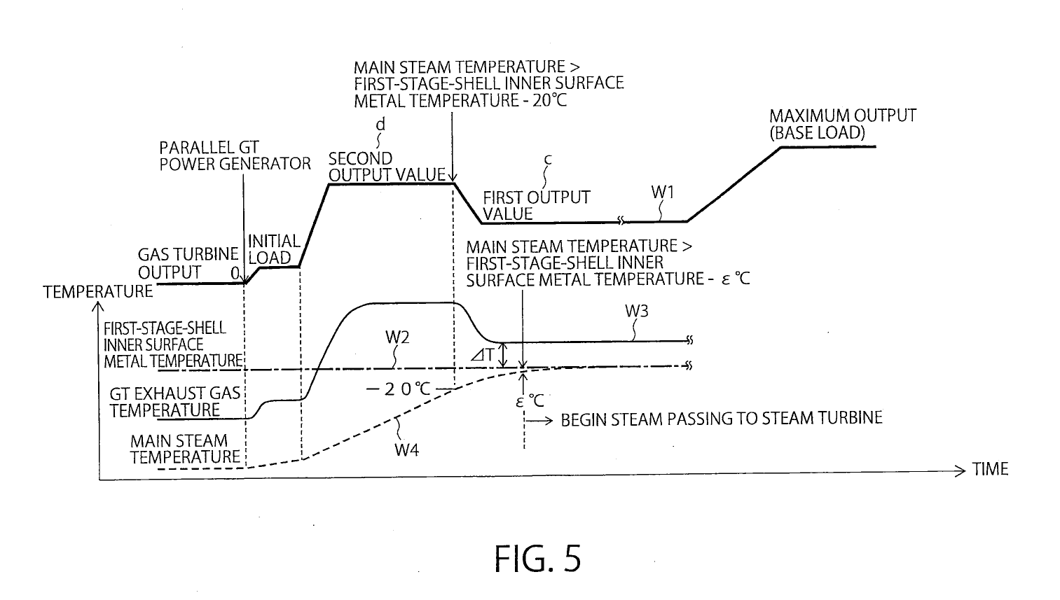

FIG. 5 is a starting chart of the starting method according to the first embodiment. In FIG. 5, as shown by a waveform W1 that shows the temporal change in the gas turbine output, the gas turbine output is switched from the above second output value “d” to the first output value “c”. Thereby, as shown by a waveform W3 that shows the temporal change in the GT exhaust gas temperature, the GT exhaust gas temperature changes depending on the gas turbine output. As shown by a waveform W4 that shows the temporal change in the main steam temperature and a waveform W2 that shows the temporal change in the first-stage-shell inner surface metal temperature in FIG. 5, the main steam temperature of the combined cycle power-generating plant 500 according to the first embodiment asymptotically rises to the first-stage-shell inner surface metal temperature quickly.

When the gas turbine output value before the steam passing to the steam turbine is begun is compared between FIG. 5 and FIG. 12, in the output chart of the comparative example in FIG. 12, it is constant at the first output value “c”. In contrast, the output chart of the first embodiment exhibits waveform feature of bulging at a part where the waveform W1 of the gas turbine output has the second output value “d”, in accordance with the magnitude relation in which the second output value “d” is greater than the first output value “c”.

As shown in FIG. 5, after paralleling (connecting) the GT power generator 517 of the gas turbine 502 to electric substation equipment, the controller CON controls the output of the gas turbine 502 at the second output value greater than the first output value, which is the gas turbine output when the exhaust gas temperature of the gas turbine 502 falls within the temperature range determined based on the metal temperature of the steam turbine 503. Here, preferably, the above-described metal temperature should be the first-stage-shell inner surface metal temperature, for example. The above-described metal temperature may be the shell inner surface metal temperature on another stage in the steam turbine 503.

Furthermore, when the temperature of the steam generated by the heat recovery steam generator 504 exceeds the temperature based on the above metal temperature (for example, a temperature that is lower than the above metal temperature by a predetermined temperature), the controller CON controls the output of the gas turbine 502 at the first output value.

When the starting scheme according to the first embodiment is adopted, the determination of the second output value “d” is an important problem. The greater the second output value “d”, the better for promoting the quick rise in the main steam temperature. However, the operation state in which the steam passing to the steam turbine 503 is not being performed although the ignition operation of the gas turbine 502 is being performed is, in a sense, under a special situation. In the case where the second output value “d” exceeds a proper value and gets to be too great, the following three situations can arise. In the following, setting methods of the second output value “d” corresponding to the situations will be explained.

(First Setting Method of Second Output Value “d”)

The first situation is a situation in which, when the second output value “d” gets to be too great, the generation flow rate of the main steam b from the superheater 511 increases and the turbine bypass regulating valve 512 fully opens at an opening degree of 100%.

That is, in the operation state shown in FIG. 1, the gas turbine 502 gets to have the second output value “d”. However, the rise in the main steam temperature is still insufficient, and the steam passing to the steam turbine 503 by the valve opening of the controlling valve 505 is not permitted. During that time, the turbine bypass regulating valve 512 leads the main steam b from the superheater 511 to the steam condenser 513 while performing the pressure control, until the steam passing is permitted.

On this occasion, in response to the second output value “d”, a large amount of main steam b flows from the superheater 511 into the turbine bypass regulating valve 512, and when the main steam b exceeds the capacity of the turbine bypass regulating valve 512, there is a fear that the opening degree is fully opened. This full opening state, in which the pressure control of the drum 510 is lost, results in an extreme fluctuation in the water level of the drum 510, and the like, and hinders the stable operation.

Hence, the output setting unit 101 according to the first embodiment may set, as the second output value “d”, the greatest gas turbine output “Y1” that does not make the opening degree of the regulating valve fully opened even when all the main steam b from the superheater 511 flows in the steam condenser 513 through the turbine bypass regulating valve 512.

In the following, a calculation method of the gas turbine output “Y₁” will be explained.

It is generally known that the main steam flow rate “G” of the main steam b is roughly proportional to the output value of the gas turbine 502, and therefore, “Y₁” is expressed by the following Formula (6), using the main steam flow rate “G”.

Y₁=αG₁ (6)

Meanwhile, the valve opening degree property of not only the turbine bypass regulating valve 512 but also a general regulating valve is expressed by the relation of the valve capacity coefficient “Cv” to the opening degree “X”. Further, the steam flow rate “G₁” which flows in the regulating valve is calculated by the following Formula (7), using the valve capacity coefficient “Cv”, the regulating valve upstream pressure “P₁”, the downstream pressure “P₂”, and the steam superheat degree “Tₛₕ”.

G₁=Cv×13.5×√((P₁−P₂)(P₁+P₂))/(1+0.00126 Tₛₕ) (7)

Therefore, the gas turbine output to the valve opening degree is calculated by the following formula that results from substituting Formula (7) into Formula (6), and the gas turbine output “Y₁” at the maximum opening degree “θMax” in the controllable area for the turbine bypass regulating valve is given by the following Formula (8).

Y₁=α×[Cv×13.5×√((P₁−P₂)(P₁+P₂))/(1+0.00126Tₛₕ)] (8)

(Second Setting Method of Second Output Value “d”)

The second situation is a situation in which, when the second output value “d” gets to be too great, the generation flow rate of the main steam b from the superheater 511 increases, and the seawater temperature difference at an inlet and outlet port of the steam condenser exceeds an allowable temperature difference and impacts on environment preservation.

That is, in the operation state shown in FIG. 1, the gas turbine 502 gets to have the second output value “d”. However, the rise in the main steam temperature is still insufficient, and the steam passing to the steam turbine 503 is not permitted. During that time, the turbine bypass regulating valve 512 leads the main steam b from the superheater 511 to the steam condenser 513 while performing the pressure control, until the steam passing is permitted. The main steam b put in the steam condenser 513 is cooled by the seawater 515 pumped by the circulating water pump 514, and condenses to become condensate. On the other hand, the temperature of the seawater 515 rises by heat exchange. On this occasion, in response to the second output value “d”, a large amount of main steam b flows from the superheater 511 into the steam condenser 513. Therefore, there is a fear that the heat exchange amount in the steam condenser 513 increases, and the seawater temperature at the outlet of the steam condenser 513 greatly rises and exceeds the environmentally allowable seawater temperature difference at the inlet and outlet port of the steam condenser 513.

Hence, the output setting unit 101 according to the first embodiment may set, as the second output value “d”, the greatest gas turbine output “Y₂” that does not make the seawater temperature difference at the inlet and outlet port of the steam condenser 513 exceed a predetermined value even when all the main steam b from the superheater 511 flows in the steam condenser 513 through the turbine bypass regulating valve 512.

In the following, a calculation method of the gas turbine output “Y₂” will be explained.

The heat exchange duty “Q_{d}” in the steam condenser 513 can be expressed by the following Formula (9) with the seawater coolant amount “W”, the seawater inlet temperature “CWT₁”, the outlet temperature “CWT₂”, and the density “γ” and specific heat “Cₚ” of the seawater that is the coolant.

Q_{d}=W×γ×Cₚ/60×(CWT₂−CWT₁) (9)

Here, all the members of “W×γ×Cₚ/60” are invariables, and the expression by the following Formula (10) is possible, where “ΔCWT” represents a temperature difference at the inlet and outlet port of the steam condenser that is at a level to keep from impacting on environment preservation.

Q_{d}=R×ΔCWT (10)

Meanwhile, as described above, it is generally known that the main steam flow rate “G₂” of the main steam b to flow in the steam condenser 513 is roughly proportional to the output value of the gas turbine 502, and this is expressed by the following Formula (11).

Y₂=ηG₂ (11)

Here, “η” is a proportionality coefficient. Furthermore, the heat exchange duty “Q_{d}” in the steam side of the steam condenser 513 can be expressed by the following Formula (12), where “G₂” represents the main steam flow rate, “H₁” represents the main steam enthalpy at the downstream side of the turbine bypass regulating valve, and “H₂” represents the enthalpy of the condensate at the steam condenser outlet.

Q_{d}′=G₂×(H₁−H₂) (12)

Since “Q_{d}′” is the same heat exchange duty as “Q_{d}”, the gas turbine output “Y₂” that does not make the seawater temperature difference at the inlet and outlet port of the steam condenser exceed the allowable temperature difference “ΔCWT” is given by the following Formula (13).

Y₂=η×ΔCWT/(H₁−H₂) (13)

### (Supplement)

After the steam passing to the steam turbine 503, the output of the gas turbine 502 rises to the maximum output. The main steam amount to be generated from the heat recovery steam generator 504 at this time exceeds the generation amount when the operation is performed using “Y₂” as the second output value. However, the steam to flow in the steam condenser 513 after the steam passing is the exhaust steam after the steam turbine 503 is driven, and the heat energy is significantly decreased compared to the main steam. Therefore, the problem of the seawater temperature difference at the inlet and outlet port of the steam condenser 513 does not arise.

(Third Setting Method of Second Output Value “d”)

For a heat exchanger as typified by the superheater 511 incorporated in the heat recovery steam generator 504, the maximum allowable working temperature is determined depending on the material to be used. It is basically impossible to take the GT exhaust gas with a temperature exceeding the maximum allowable working temperature. In the case where the main steam b is generated by the heat recovery steam generator 504, the main steam b exerts the effect of the cooling from the interior of the tube of the heat exchanger, and therefore, there is no problem even when the GT exhaust gas temperature exceeds the maximum allowable working temperature.

However, in the starting scheme according to the first embodiment, the operation with the second output value “d” is performed at a stage during which the main steam is not generated (or there is extremely little main steam). Therefore, a so-called “boil-dry of the heat exchanger” by the flow with the GT exhaust gas temperature exceeding the maximum allowable working temperature can occur.

Hence, the output setting unit 101 according to the first embodiment may set, as the second output value “d”, the greatest gas turbine output “Y₃” that gives a GT exhaust gas temperature not exceeding the maximum allowable working temperature of the heat exchanger incorporated in the heat recovery steam generator 504.

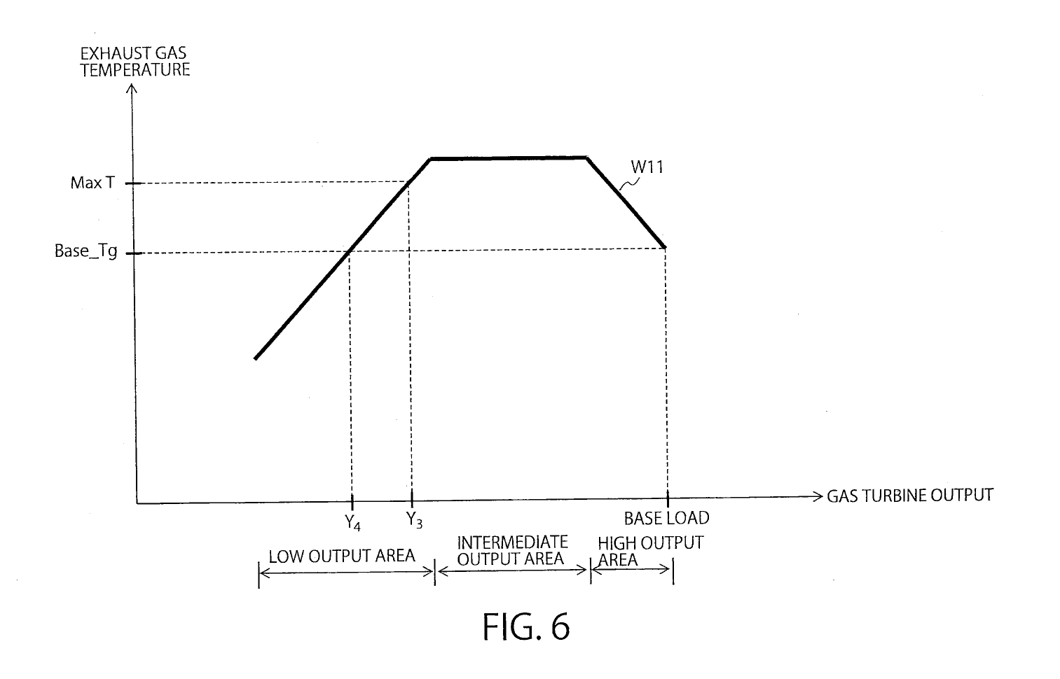

The gas turbine output “Y₃” is determined as follows. Typically, in the gas turbine design, the maximum value of the GT exhaust gas temperature is in a range of 600° C. to 650° C., and the maximum allowable working temperature of the heat exchanger is ordinarily determined between 550° C. and 600° C. in consideration of the economic efficiency and the like. Hereinafter, the GT exhaust gas temperature that is the maximum allowable working temperature of the heat exchanger is referred to as the “MaxT”. The relation between the output of the gas turbine 502 and the GT exhaust gas temperature is uniquely determined as shown by a graph of FIG. 6.

FIG. 6 is a graph showing an example of the relation between the output of the gas turbine 502 and the GT exhaust gas temperature. A waveform W11 showing the GT exhaust gas temperature with respect to the output of the gas turbine 502 is shown.

Here, in the waveform W11, the gas turbine output corresponding to the GT exhaust gas temperature “MaxT” that is the maximum allowable working temperature of the heat exchanger is the greatest gas turbine output “Y₃” that gives the GT exhaust gas temperature not exceeding the maximum allowable working temperature of the heat exchanger.

Thus, when the GT exhaust gas temperature “MaxT” that is the maximum allowable working temperature of the heat exchanger is determined, the gas turbine output “Y₃” is obtained in the light of the relation between the output of the gas turbine 502 and the GT exhaust gas temperature.

(Fourth Setting Method of Second Output Value “d”)

The above gas turbine outputs “Y₁”, “Y₂” and “Y₃” that can be set as the second output value “d” are all determined from the standpoint of the maximum gas turbine output that is allowed before the steam passing to the steam turbine 503. However, it is pointed out that the gas turbine operation by the allowable limit has a harmful effect. The gas turbine 502 for the combined cycle power-generating plant as a commercial machine requires the so-called governor-free operation, and therefore, typically, the DROOP control is applied. In the DROOP control, a decrease in the frequency of the system grid is detected, and depending on the frequency deviation, a bias amount of fuel 516 (output) is applied. When the gas turbine 502 is operated at the gas turbine output “Y₁”, “Y₂” or “Y₃” that is the allowable limit, the application of the bias amount results in an output and GT exhaust gas temperature that exceed the allowable limit.

In response, the output setting unit 101 according to the first embodiment may estimate the maximum value of the first output value “c”, from the maximum temperature (upper limit value) of the first-stage-shell inner surface metal temperature that is assumed at the time of the plant starting, and may set this as the second output value “d”. In this setting, no matter what first-stage-shell inner surface metal temperature the plant starting involves, it is possible to determine a second output value “d” that is necessarily an output greater than the first output value “c”, by a relatively simple technique.

In the following, this second output value “d” will be explained.

For assuming the maximum temperature (upper limit value) of the first-stage-shell inner surface metal temperature, suppose a series of sequences in which the combined cycle power-generating plant 500 is stopped in a state in which the plant is being operated at the maximum gas turbine output (base load), and the next plant starting is performed after a certain time elapses. While a first-stage-shell inner surface metal temperature when the operation is performed at the base load (this is referred to as a base-load metal temperature “Base_Tm”) is kept as the first-stage-shell inner surface metal temperature, the plant stop (steam turbine trip) is performed. Then, the temperature is reduced by natural cooling, depending on the stop time after the trip time point that is the starting point and before the next plant starting. In other words, the first-stage-shell inner surface metal temperature at the next plant starting, to a varying degree, is necessarily lower than the base-load metal temperature “Base_Tm”, because of the natural cooling. Therefore, it is possible to estimate that the maximum temperature (upper limit value) of the first-stage-shell inner surface metal temperature to be reasonably assumed at the time of the plant starting is the base-load metal temperature “Base_Tm”.

On the other hand, as described above, the GT exhaust gas temperature target value for the main steam temperature matching control is expressed by the following Formula (5).

GT Exhaust Gas Temperature Target Value=First-Stage-Shell Inner Surface Metal Temperature+ΔT (5)

By substituting the base-load metal temperature “Base_Tm” into the first-stage-shell inner surface metal temperature of the right-hand side of Formula (5), the highest GT exhaust gas temperature target value is expressed by the following Formula (14).

Highest GT Exhaust Gas Temperature Target Value=Base_{—}Tm+ΔT (14)

On the other hand, the relation between the GT exhaust gas temperature and the first-stage-shell inner surface metal temperature is given as the above-described Formula (4) (GT exhaust gas temperature=first-stage-shell inner surface metal temperature+ΔT). When the GT exhaust gas temperature at the time of the base load operation is described as “Base_Tg” and the relation of Formula (4) is applied to the case of the base load, the following Formula (15) holds.

Base_{—}Tg=Base_{—}Tm+ΔT (15)

When “Base_Tm” and “ΔT” are eliminated from Formula (14) and Formula (15), the following Formula (16) is obtained.

Highest GT Exhaust Gas Temperature Target Value=Base_{—}Tg (16)

That is, it is shown that the highest GT exhaust gas temperature target value to be assumed at the time of the plant starting is the GT exhaust gas temperature “Base_Tg” at the time of the base load (maximum output). Therefore, it is possible to assume that the greatest first output value “c” to be generated at the time of the plant starting is the gas turbine output to give the exhaust gas temperature of “Base_Tg”. If thinking it primitively, it appears that the gas turbine output capable of providing a GT exhaust gas temperature equivalent to the “GT exhaust gas temperature (Base_Tg) at the base load” is not present other than the base load.

However, it is suggested that this is not the right answer, if focusing attention on the gas turbine output and the property of the GT exhaust gas temperature shown in the graph of FIG. 6. That is, when the gas turbine output on the abscissa axis of the property graph is divided into a low output area, an intermediate output area and a high output area, there is a property (a property with a convex shape) in which the output having the highest GT exhaust gas temperature is in the intermediate output area, and the low output area and the high output area have lower exhaust gas temperatures than that.

Therefore, as shown in FIG. 6, there is a gas turbine output “Y₄” that is in the low output area and that gives an exhaust gas temperature equivalent to “Base_Tg”. In other words, when the gas turbine 502 is operated such that the first output value “c” is the gas turbine output “Y₄”, the GT exhaust gas temperature is “Base_Tg”, which is equivalent to the base load (maximum output).

The gas turbine output “Y₄” is the maximum value of the first output value “c” that is reasonably assumed, and the output setting unit 101 according to the first embodiment may set the gas turbine output “Y₄”, as the second output value “d”.

To summarize the above, the second output value “d” by the fourth setting method is set as follows. The gas turbine 502 has a property that the intermediate output area of the gas turbine output is higher in the exhaust gas temperature than the low output area, which is lower in the gas turbine output than the intermediate output area, and the high output area, which is higher in the gas turbine output than the intermediate output area. Then, the output setting unit 101 may set, as the second output value “d”, the gas turbine output “Y₄” that is in the low output area and that gives the exhaust gas temperature equivalent to the exhaust gas temperature “Base_Tg” at the time of the maximum output (base load) of the gas turbine 502.

When the second output value “d” is the gas turbine output “Y₄” in this way, the second output value “d” is necessarily an output greater than the first output value “c”, no matter what the first-stage-shell inner surface metal temperature (lower than “Base_Tm”) is at the time of the plant starting. An intention of the starting according to the first embodiment is a starting method of realizing the magnitude relation of the second output value “d”>the first output value “c” and promoting the early rise in the main steam temperature. In the case of a starting method in which the first output value “c”>the second output value “d” holds inversely, the advantage is lost, leading to a nonsensical starting method.

What is needed for the calculation of the gas turbine output “Y₄” is the relation between the gas turbine output and the GT exhaust gas temperature in FIG. 6, which is a typical property of the combined cycle power-generating plant 500 and is data to be comprehended relatively easily. Therefore, the output setting unit 101 can determine an appropriate second output value “d”, by a relatively simple technique. The base load fluctuates depending on the atmospheric temperature, and because of that, “Base_Tg” and “Y₄” also are values that slightly fluctuate. However, when the average air temperature (for example, 15° C.) at a construction site for the combined cycle power-generating plant 500 is selected, and based on the base load therefor, they are determined, an error by the atmospheric temperature does not create a major problem. In contrast, in the case where the gas turbine output “Y₁” or “Y₂” is determined as the above-described second output value “d”, the calculation requires many data based on heat balance data, and a complex calculation.

(Fifth Setting Method of Second Output Value “d”)

Next, a fifth setting method of the second output value “d” will be explained. As described above, when the gas turbine 502 is operated at the output of “Y₄”, the GT exhaust gas temperature is “Base_Tg”. From the above Formula (7), the relation between “Base_Tg” and “Base_Tm” is expressed by the following Formula (15), as described above.

Base_{—}Tg=Base_{—}Tm+ΔT (15)

That is, when the gas turbine 502 is operated at the gas turbine output “Y₄”, the first-stage-shell inner surface metal temperature is “Base_Tm”. Therefore, when setting the gas turbine output “Y₄” as the second output value “d”, the output setting unit 101 may set it as follows, using the first-stage-shell inner surface metal temperature instead of the GT exhaust gas temperature in the above-described fourth setting method.

To summarize the above, the second output value “d” according to the fifth setting method is set as follows. The gas turbine 502 has a property that the intermediate output area of the gas turbine output is higher in the exhaust gas temperature than the low output area, which is lower in the gas turbine output than the intermediate output area, and the high output area, which is higher in the gas turbine output than the intermediate output area. Then, the output setting unit 101 may set, as the second output value “d”, a gas turbine output “Y₄” that is in the low output area and that gives a first-stage-shell inner surface metal temperature equivalent to the first-stage-shell inner surface metal temperature at the time of the maximum output (base load) of the gas turbine 502.

(Sixth Setting Method of Second Output Value “d”)

Next, a sixth setting method of the second output value “d” will be explained. As described above, when the gas turbine 502 is operated at the gas turbine output “Y₄”, the first-stage-shell inner surface metal temperature is “Base_Tm”, and further, in the normal operation state in which the gas turbine 502 is operated at the base load, the main steam temperature and the first-stage-shell inner surface metal temperature match (that is, the mismatch temperature=0).

Therefore, the second output value “d” by the sixth setting method may be set as follows, using the main steam temperature instead of the first-stage-shell inner surface metal temperature.

The gas turbine 502 has a property that the intermediate output area of the gas turbine output is higher in the exhaust gas temperature than the low output area, which is lower in the gas turbine output than the intermediate output area, and the high output area, which is higher in the gas turbine output than the intermediate output area. Then, the output setting unit 101 may set, as the second output value “d”, a gas turbine output “Y₄” that is in the low output area and that gives a main steam temperature equivalent to the main steam temperature at the time of the maximum output (base load) of the gas turbine 502.

In the calculation of the gas turbine “Y₄” in the fifth setting method and the sixth setting method, it can be calculated by a relatively simple technique, using heat balance data at the time of the base load, and the like, in addition to the relation between the gas turbine output and the GT exhaust gas temperature in FIG. 6.

(Seventh Setting Method of Second Output Value “d”)

In the above-described first setting method to third setting method, the second output value “d” is set to any of “Y₁”, “Y₂” and “Y₃”, and all of them are determined from the standpoint of the maximum gas turbine output that is allowed before the steam passing to the steam turbine 503. However, these respective allowable limit values are highly related to the construction cost of the combined cycle power-generating plant 500. For example, when a small capacity valve that is cheap and therefore has a small dimension or size is adopted as the turbine bypass regulating valve 512, the gas turbine output “Y₁” to be set as the second output value “d” is smaller than the other gas turbine outputs “Y₂” and “Y₃”.

Thus, for each of the gas turbine outputs “Y₁”, “Y₂” and “Y₃” to be set as the second output value “d”, the magnitude relation varies for each plant, depending on the cost by the related equipment specification and/or the economic efficiency. Therefore, when the second output value “d” is actually determined, it is reasonable to select the minimum value of the gas turbine outputs “Y₁”, “Y₂” and “Y₃”.

Further, typically, “Y₄” to be set as the second output value “d” by the fourth setting method to the sixth setting method seems to be smaller than “Y₁”, “Y₂” and “Y₃”. However, in the seventh setting method, for the sake of a further certainty and reasonability, the output setting unit 101 may set, as the second output value “d”, the minimum value of the gas turbine outputs “Y₁”, “Y₂”, “Y₃” and “Y₄”.

Thus, the controlling apparatus 501 according to the first embodiment controls the combined cycle power-generating plant including the gas turbine 502, the heat recovery steam generator 504 that recovers heat from the exhaust gas of the gas turbine 502 and generates steam, and the steam turbine 503 that is driven by the steam generated by the heat recovery steam generator 504.

Then, after the paralleling of the GT power generator 517 is performed to the gas turbine 502, the controller CON controls the output of the gas turbine 502 at the second output value that is greater than the first output value, which is the gas turbine output when the exhaust gas temperature of the gas turbine 502 falls within the temperature range to be determined based on the metal temperature of the steam turbine 503. Then, in the case where the temperature of the steam generated by the heat recovery steam generator 504 exceeds the temperature based on the above metal temperature (for example, a temperature that is lower than the above metal temperature by a predetermined temperature), the controller CON controls the output of the gas turbine 502 at the first output value “c”.

Thereby, the second output value d″ is set as the gas turbine output, a more energetic heat recovery is performed, and therewith the temperature rise of the main steam b is performed. Thereafter, at a proper timing, it is possible to switch to the gas turbine output depending on the first-stage-shell inner surface metal temperature. Therefore, a rapid temperature rise in the main steam b is possible, and eventually, it is possible to shorten the starting time of the combined cycle power-generating plant 500.

### Second Embodiment

Next, a second embodiment will be explained. In the first embodiment, when the temperature of the steam generated by the heat recovery steam generator 504 exceeds the temperature that is lower than the first-stage-shell inner surface metal temperature by the predetermined temperature, the controller CON shifts the output of the gas turbine 502 from the second output value “d” to the first output value “c” that is smaller than the second output value “d”. On this occasion, the first output value “c” is a gas turbine output at which the gas turbine exhaust gas temperature is within the allowable deviation range (within “±β° C.”) of the GT exhaust gas temperature target value (=first-stage-shell inner surface metal temperature+ΔT). Thereby, it is possible to reduce, to the upmost, the thermal stress to be generated by the steam passing to the steam turbine.

Meanwhile, in a cold starting in which the operation of the combined cycle power-generating plant is suspended for a long time and the first-stage-shell inner surface metal temperature is cooled to a low temperature state, it is necessary to perform the steam passing to the steam turbine with a low-temperature main steam, and to reduce the generated thermal stress. Therefore, the first output value “c” is lowered, and thereby, the gas turbine exhaust gas temperature also gets to be a low temperature.

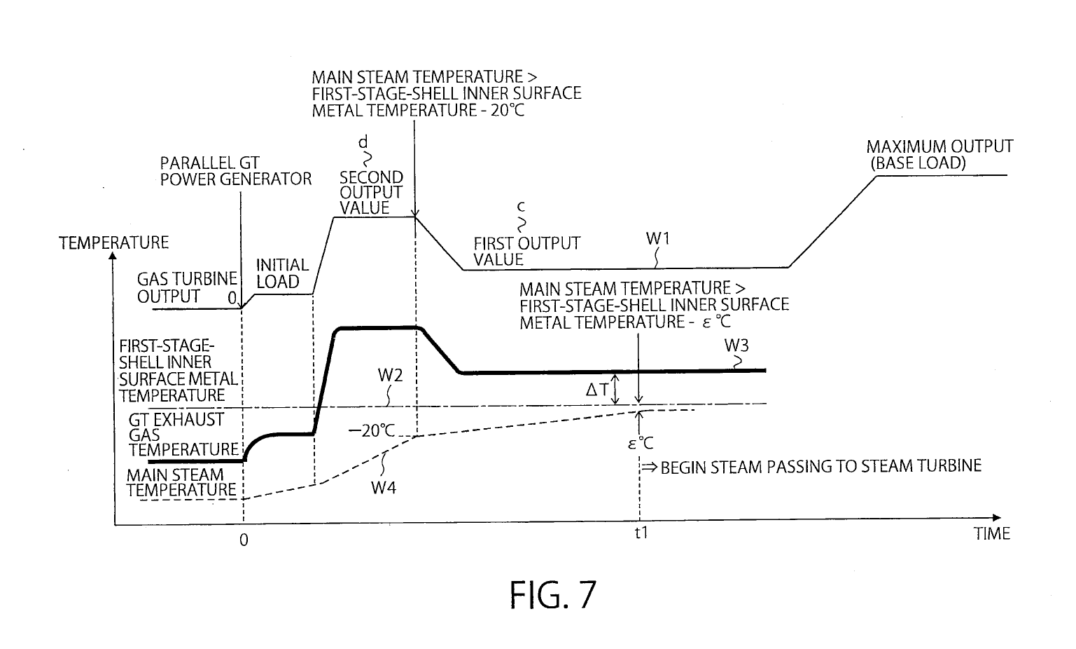

FIG. 7 is an example of the starting chart when the starting method according to the first embodiment is used in the cold starting. As shown in FIG. 7, after the main steam temperature reaches not less than “first-stage-shell inner surface metal temperature−20° C.”, and the output of the gas turbine shifts to the first output value “c”, the rise rate of the main steam temperature decreases, because the gas turbine exhaust gas temperature is low. This prolongs the required time “t1” after the paralleling of the gas turbine 502 with the GT power generator 517 and before the main steam temperature reaches a temperature that allows the steam passing to the steam turbine 503 to be begun (that is, “first-stage-shell inner surface metal temperature−ε”).

This has a problem in that the advantage of the shortening of the starting time of the combined cycle power-generating plant, which is an effect of the first embodiment, is offset. Furthermore, in a serious case, when the output of the gas turbine is shifted to the first output value “c”, the rise rate of the main steam temperature extremely decreases, and the change in the main steam temperature per unit time gets to be a minus value. Thereby, the main steam temperature decreases to not greater than “first-stage-shell inner surface metal temperature−20° C.”, again, and in some cases, the required time before the main steam temperature reaches “first-stage-shell inner surface metal temperature−ε”, which allows the steam passing to the steam turbine 503 to be begun, is further prolonged, relative to the required time “t1” in FIG. 7.

In contrast, the controller CON according to the second embodiment controls the output of the gas turbine 502 at the first output value “c”, when the temperature of the steam generated by the heat recovery steam generator 504 exceeds a temperature that is higher than the first-stage-shell inner surface metal temperature by a predetermined temperature.

A schematic configuration diagram showing the configuration of the combined cycle power-generating plant 500 according to the second embodiment, a schematic block diagram showing the configuration of the controlling apparatus 501, and a cross unital view of the steam turbine 503 are the same as the first embodiment. That is, the schematic configuration diagram showing the configuration of the combined cycle power-generating plant 500 according to the first embodiment in FIG. 1, the configuration of the controlling apparatus 501 in FIG. 2, and the cross unital view of the steam turbine 503 in FIG. 3 are the same as the second embodiment, and therefore, the detailed explanations are omitted.

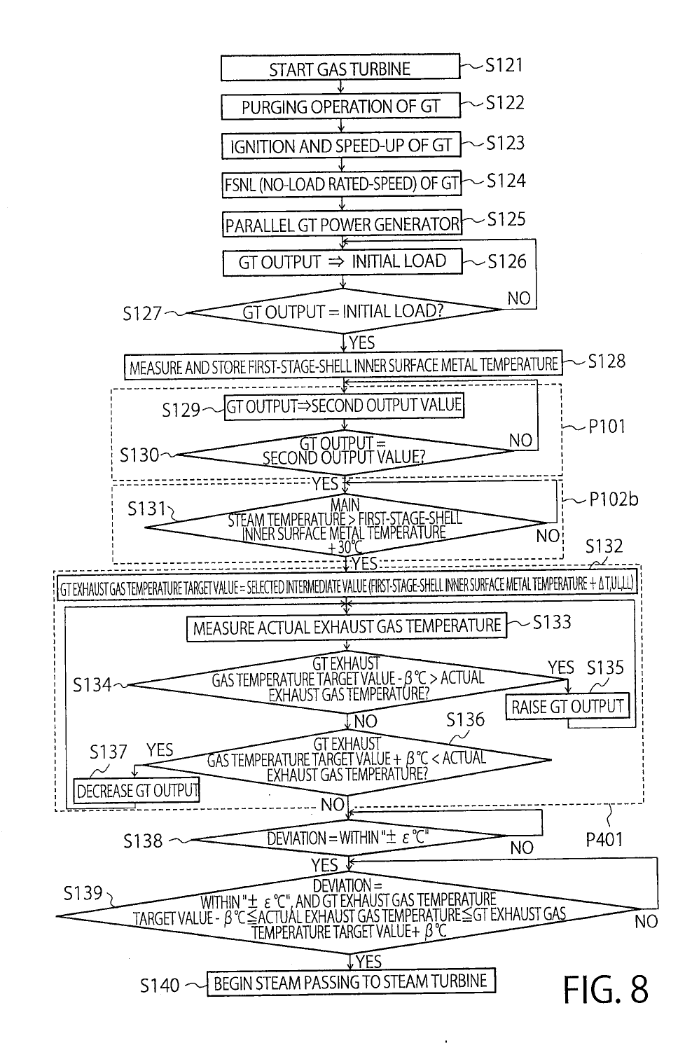

Next, the starting process of the combined cycle power-generating plant 500 according to the second embodiment will be explained, using FIG. 8. FIG. 8 is a flowchart showing a starting algorithm according to the second embodiment. The processes of steps S121 to S130 are the same as steps S101 to S110 in FIG. 4, and therefore, the explanations are omitted.

In FIG. 8, a judging process P102b for judging a timing at which the second output value “d” is switched to the first output value “c” is different from the judging process P102 according to the first embodiment in FIG. 4. Specifically, in the judging process P102 according to the first embodiment, at the timing shortly before reaching the target temperature, that is, when the main steam temperature exceeds the temperature that is lower than the first-stage-shell inner surface metal temperature by 20° C., the controller CON performs such a control that the gas turbine output is switched from the second output value “d” to the first output value “c”. However, as described above, in the case of the cold starting, after the shift to the first output value “c”, the rise rate of the main steam temperature decreases, and much time is required before the main steam temperature reaches the temperature that allows the steam passing to the steam turbine to be begun (that is, “first-stage-shell inner surface metal temperature−ε”).

Hence, in the second embodiment, when the main steam temperature exceeds a temperature that is higher than the first-stage-shell inner surface metal temperature by a predetermined temperature, the controller CON performs such a control that the gas turbine output is switched from the second output value “d” to the first output value “c”.

In the following, the reason for performing such a control will be explained. From the standpoint of thermal stress, the ideal main steam temperature is equal to the first-stage-shell inner surface metal temperature, and therefore, it is possible that the switching to the first output value “c” is performed when the main steam temperature matches with the first-stage-shell inner surface metal temperature. However, in the case of the cold starting, by this switching timing, the gas turbine exhaust gas temperature after the switching to the first output value “c” gets to be a low temperature, and therefore, similarly to the above-described phenomenon, there is a fear that the change in the main steam temperature per unit time is turned to a minus value, and the main steam temperature decreases to the first-stage-shell inner surface temperature or less, again.

On the contrary, in the case of performing the switching from the second output value “d” to the first output value “c” when exceeding a temperature that is extremely higher than the first-stage-shell inner surface metal temperature, a harmful effect of rather delaying the beginning of the steam passing to the steam turbine arises because of a too great overshoot of the main steam temperature.

Hence, when the main steam temperature exceeds a temperature that is higher than the first-stage-shell inner surface metal temperature by a predetermined temperature, the controller CON controls the fuel regulating valve 506 such that the gas turbine output is switched from the second output value “d” to the first output value “c”. In the embodiment, as an example, the predetermined temperature is 30° C., and the controller CON judges whether the main steam temperature exceeds a temperature that is higher than the first-stage-shell inner surface metal temperature by 30° C. (step S131). As a result of the judgment, in the case where the main steam temperature exceeds the temperature that is higher than the first-stage-shell inner surface metal temperature by 30° C. (YES in step S131), the main steam temperature matching controller 401 begins the main steam temperature matching process P401. Thus, in this case, the main steam temperature temporarily overshoots the first-stage-shell inner surface metal temperature, which is the target, to the temperature that is higher by 30° C.

A main steam temperature matching process P401 in FIG. 8 is the same as the main steam temperature matching process P401 according to the first embodiment in FIG. 4, and therefore, the detailed explanation is omitted.

Subsequently, in a stage during which the main steam temperature matching controller 401 executes the main steam temperature matching process P401, the gas turbine output decreases to the first output value “c”. As a result, after the shift to the first output value “c”, the gas turbine exhaust gas temperature, because of a low temperature, promptly decreases toward the first-stage-shell inner surface metal temperature.

Then, the controller CON judges whether the deviation between the main steam temperature and the first-stage-shell inner surface metal surface is within a predetermined allowable deviation (within “±ε”) (step S138). When the main steam temperature has decreased to “first-stage-shell inner surface metal temperature+ε° C.”, the judgment that the deviation between the first-stage-shell inner surface metal temperature and the main steam temperature is a sufficiently small allowable deviation is made (YES in step S138).

In that case (YES in step S138), the controller CON judges whether the deviation between the main steam temperature and the first-stage-shell inner surface metal temperature is within the predetermined allowable deviation and the exhaust gas temperature of the gas turbine is not less than “GT exhaust gas temperature target value−β° C.” and not greater than “GT exhaust gas temperature target value+β° C.” (step S139). In the case where the deviation between the main steam temperature and the first-stage-shell inner surface metal temperature is within the predetermined allowable deviation and the exhaust gas temperature of the gas turbine is not less than “GT exhaust gas temperature target value−β° C.” and not greater than “GT exhaust gas temperature target value+β° C.” (YES in step S139), the controller CON opens the controlling valve 505 that regulates the flow rate of the steam to flow in the steam turbine 503, and begins the steam passing to the steam turbine 503 (step S140).

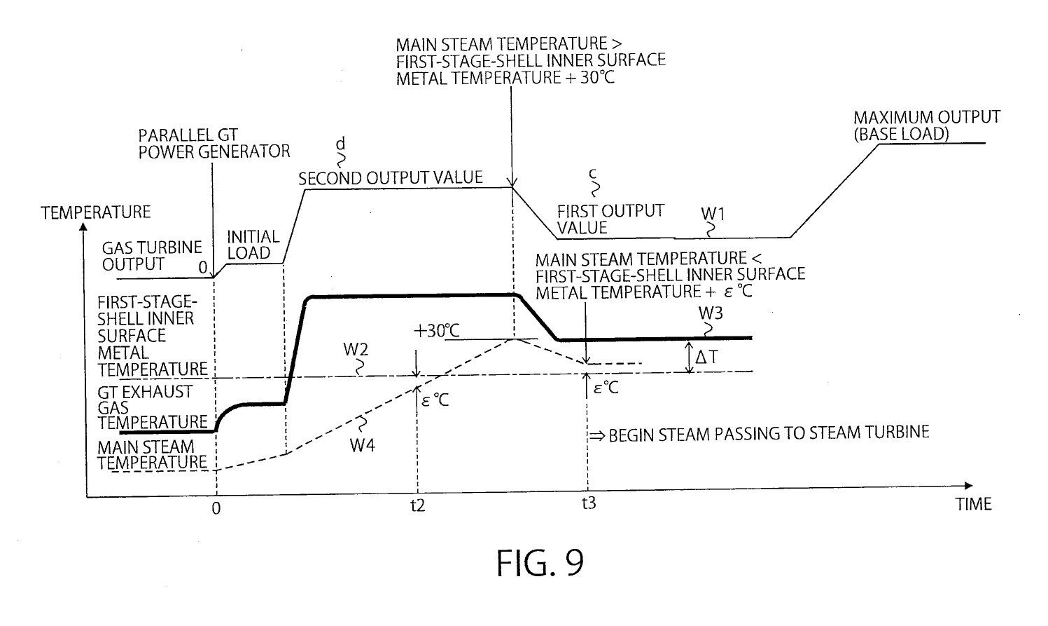

FIG. 9 is a starting chart of the starting method according to the second embodiment. In FIG. 9, as shown by a waveform W1 that shows the temporal change in the gas turbine output, the gas turbine output is switched from the above second output value “d” to the first output value “c”. Thereby, as shown by a waveform W3 that shows the temporal change in the GT exhaust gas temperature, the GT exhaust gas temperature is lowered as the gas turbine output decreases. As shown by a waveform W4 that shows the temporal change in the main steam temperature and a waveform W2 that shows the temporal change in the first-stage-shell inner surface metal temperature in FIG. 9, the main steam temperature of the combined cycle power-generating plant 500 according to embodiment quickly rises until exceeding the first-stage-shell inner surface metal temperature by 30° C. The main steam temperature temporarily overshoots the first-stage-shell inner surface metal temperature until exceeding it by 30° C., and therefrom, asymptotically approximates toward the first-stage-shell inner surface metal temperature rapidly.

Comparing the time required for the steam passing to the steam turbine between FIG. 9 and FIG. 7 from the standpoint of the rise speed of the main steam temperature, in the waveform W4 that shows the temporal change in the main steam temperature in FIG. 7, the rise speed decreases at the time point of “first-stage-shell inner surface metal temperature−20° C.”, and a long time is required before the steam passing to the steam turbine. In contrast, in the waveform W4 according to the embodiment in FIG. 9, a high rise speed is kept until the time point of “first-stage-shell inner surface metal temperature+30° C.”, and an asymptotic time for decreasing to “first-stage-shell inner surface metal temperature+ε° C.” from there is additionally required. Nevertheless, a required time “t3” in FIG. 9 after the paralleling of the GT power generator 517 and before the beginning of the steam passing to the steam turbine 503 is shortened relative to the required time “t1” in FIG. 7. Therefore, the starting time of the combined cycle power-generating plant is shortened relative to FIG. 7.

Next, the necessity of the process of step S139 in FIG. 8 will be explained. In FIG. 9, the time when the deviation between the main steam temperature and the first-stage-shell inner surface metal temperature gets to be within the predetermined allowable deviation (within “±ε”) appears twice. The first time is, as shown by time “t2” in FIG. 9, the time when the main steam temperature has risen to “first-stage-shell inner surface metal temperature−ε° C.” while the second output value “d” is kept. The second time is, as shown by time “t3” in FIG. 9, the time when the main steam temperature has dropped to “first-stage-shell inner surface metal temperature+ε° C.” after the switching to the first output value “c”.

It is necessarily required that the steam passing to the steam turbine 503 is begun at time “t3”, and for avoiding the steam passing to the steam turbine 503 from being mistakenly begun at time “t2”, the controlling apparatus 501 needs to definitely discriminate between time “t2” and time “t3”. In response, the second embodiment focuses attention on a difference between time “t2” and time “t3” in that the former is a time when the gas turbine output is the second output value “d” and the latter is a time when the gas turbine output is the first output value “c”.

In the case where the deviation between the main steam temperature and the first-stage-shell inner surface metal temperature is within the predetermined allowable deviation and the gas turbine 502 is the first output value “c”, because of corresponding to time “t3”, the controller CON begins the steam passing to the steam turbine 503. Specifically, the controller CON judges whether the deviation between the main steam temperature and the first-stage-shell inner surface temperature is within the allowable deviation (within “±ε° C.”), and the gas turbine exhaust gas temperature is not less than “GT exhaust gas temperature target value−β” and not greater than “GT exhaust gas temperature target value+β” (within “GT exhaust gas temperature target value±β° C.”). In the case where both are satisfied, the controller CON opens the controlling valve 505 that regulates the flow rate of the steam to flow in the steam turbine. Thereby, the controller CON begins the steam passing to the steam turbine 503.

Thus, in the controlling apparatus 501 according to the second embodiment, when the temperature of the steam generated by the heat recovery steam generator 504 exceeds the temperature that is higher than the above metal temperature by the predetermined temperature, the controller CON controls the output of the gas turbine 502 at the first output value “c”. Here, the metal temperature according to the embodiment is, as an example, the first-stage-shell inner surface metal temperature of the steam turbine 503.

Thereby, it is possible to shorten the time required after the paralleling of the GT power generator 517 and before the beginning of the steam passing to the steam turbine 503, and therefore, it is possible to shorten the starting time of the combined cycle power-generating plant 500.

Further, in the case where the deviation between the temperature of the steam generated by the heat recovery steam generator 504 and the first-stage-shell inner surface metal temperature is within the predetermined allowable deviation and the output of the gas turbine 502 is the first output value “c”, the controller CON according to the second embodiment opens the controlling valve 505 that regulates the flow rate of the steam to flow in the steam turbine 503. Here, the case where the output of the gas turbine 502 is the first output value “c” is a case where the exhaust gas temperature of the gas turbine falls within a temperature range to be determined based on the first-stage-shell inner surface metal temperature (specifically, first-stage-shell inner surface metal temperature+ΔT−β≦exhaust gas temperature of gas turbine≦first-stage-shell inner surface metal temperature+ΔT+β).

Thereby, when the main steam temperature has dropped to “first-stage-shell inner surface metal temperature+ε° C.” (time “t3” in FIG. 9) after the output of the gas turbine 502 was switched to the first output value “c”, the steam passing to the steam turbine 503 can be begun. Thus, when the main steam temperature converges near the first-stage-shell inner surface metal temperature, the steam passing to the steam turbine 503 can be begun, and therefore, it is possible to suppress the thermal stress to be generated in the steam turbine 503.

Here, in the second embodiment, the case of the cold starting has been explained as an example. However, also in the case of the hot starting, the combined cycle power-generating plant 500 may be started, using the starting method explained in the second embodiment.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A controlling apparatus to control a combined cycle power-generating plant, the combined cycle power-generating plant comprising: a gas turbine; an heat recovery steam generator that recovers heat from exhaust gas of the gas turbine and generates steam; and a steam turbine that is driven by the steam generated by the heat recovery steam generator,
wherein the controlling apparatus comprises a controller that controls an output of the gas turbine,
the controller controls the output of the gas turbine at a second output value that is greater than a first output value, after a paralleling of a power generator of the gas turbine, the first output value being a gas turbine output when an exhaust gas temperature of the gas turbine falls within a temperature range that is determined based on a metal temperature of the steam turbine, and
the controller controls the output of the gas turbine at the first output value, in a case where a temperature of the steam generated by the heat recovery steam generator exceeds a temperature based on the metal temperature.

2. The controlling apparatus according to claim 1,
wherein the controlling apparatus controls the output of the gas turbine at the first output value, in a case where the temperature of the steam generated by the heat recovery steam generator exceeds a temperature that is higher than the metal temperature by a predetermined temperature.

3. The controlling apparatus according to claim 2,
wherein the metal temperature is a first-stage-shell inner surface metal temperature of the steam turbine, and
the controller opens a controlling valve that regulates a flow rate of the steam to flow in the steam turbine, in a case where a deviation between the temperature of the steam generated by the heat recovery steam generator and the first-stage-shell inner surface metal temperature is within a predetermined allowable deviation and the output of the gas turbine is the first output value.

4. The controlling apparatus according to claim 3,
wherein the case where the output of the gas turbine is the first output value is a case where the exhaust gas temperature of the gas turbine falls within a temperature range that is determined based on the first-stage-shell inner surface metal temperature.

5. The controlling apparatus according to claim 1,
wherein the controller controls the output of the gas turbine at the first output value, in a case where the temperature of the steam generated by the heat recovery steam generator exceeds a temperature that is lower than the metal temperature by a predetermined temperature.

6. The controlling apparatus according to claim 1,
wherein the metal temperature is a first-stage-shell inner surface metal temperature of the steam turbine.

7. The controlling apparatus according to claim 1,
wherein the second output value is the greatest gas turbine output that does not make an opening degree of a turbine bypass regulating valve fully opened when all the steam generated by the heat recovery steam generator flows in a steam condenser through the turbine bypass regulating valve.

8. The controlling apparatus according to claim 1,
wherein the second output value is the greatest gas turbine output that does not make a seawater temperature difference at an inlet and outlet port of a steam condenser exceed a predetermined value when all the steam generated by the heat recovery steam generator flows in the steam condenser through the turbine bypass regulating valve.

9. The controlling apparatus according to claim 1,
wherein the second output value is the greatest gas turbine output that gives a gas-turbine exhaust gas temperature not exceeding a maximum allowable working temperature of a heat exchanger incorporated in the heat recovery steam generator.

10. The controlling apparatus according to claim 1,
wherein the gas turbine has a property that an intermediate output area of the gas turbine output is higher in the exhaust gas temperature than a low output area and a high output area, the low output area being lower in the gas turbine output than the intermediate output area, the high output area being higher in the gas turbine output than the intermediate output area, and
the second output value is a gas turbine output that is in the low output area and that gives an exhaust gas temperature equivalent to a gas-turbine exhaust gas temperature at the time of the maximum output of the gas turbine.

11. The controlling apparatus according to claim 1,
wherein the gas turbine has a property that an intermediate output area of the gas turbine output is higher in the exhaust gas temperature than a low output area and a high output area, the low output area being lower in the gas turbine output than the intermediate output area, the high output area being higher in the gas turbine output than the intermediate output area, and
the second output value is a gas turbine output that is in the low output area and that gives a first-stage-shell inner surface metal temperature equivalent to a first-stage-shell inner surface metal temperature of the steam turbine at the time of the maximum output of the gas turbine.

12. The controlling apparatus according to claim 1,
wherein the gas turbine has a property that an intermediate output area of the gas turbine output is higher in the exhaust gas temperature than a low output area and a high output area, the low output area being lower in the gas turbine output than the intermediate output area, the high output area being higher in the gas turbine output than the intermediate output area, and
the second output value is a gas turbine output that is in the low output area and that gives a main steam temperature equivalent to a main steam temperature at the time of the maximum output of the gas turbine.

13. The controlling apparatus according to claim 1,
wherein the gas turbine has a property that an intermediate output area of the gas turbine output is higher in the exhaust gas temperature than a low output area and a high output area, the low output area being lower in the gas turbine output than the intermediate output area, the high output area being higher in the gas turbine output than the intermediate output area,
the second output value is the minimum value of a first gas turbine output, a second gas turbine output, a third gas turbine output and a fourth gas turbine output,
the first gas turbine output being the greatest gas turbine output that does not make an opening degree of a turbine bypass regulating valve fully opened when all the steam generated by the heat recovery steam generator flows in a steam condenser through the turbine bypass regulating valve,
the second gas turbine output being the greatest gas turbine output that does not make a seawater temperature difference at an inlet and outlet port of the steam condenser exceed an allowable temperature difference when all the steam generated by the heat recovery steam generator flows in the steam condenser through the turbine bypass regulating valve,
the third gas turbine output being the greatest gas turbine output that gives a gas-turbine exhaust gas temperature not exceeding a maximum allowable working temperature of a heat exchanger incorporated in the heat recovery steam generator, and
the fourth gas turbine being any of a gas turbine output that is in the low output area and that gives an exhaust gas temperature equivalent to a gas-turbine exhaust gas temperature at the time of the maximum output of the gas turbine, a gas turbine output that is in the low output area and that gives a first-stage-shell inner surface metal temperature equivalent to a first-stage-shell inner surface metal temperature of the steam turbine at the time of the maximum output of the gas turbine, and a gas turbine output that is in the low output area and that gives a main steam temperature equivalent to a main steam temperature at the time of the maximum output of the gas turbine.

14. A starting method of starting a combined cycle power-generating plant, the combined cycle power-generating plant comprising: a gas turbine; an heat recovery steam generator that recovers heat from exhaust gas of the gas turbine and generates steam; and a steam turbine that is driven by the steam generated by the heat recovery steam generator,
wherein the starting method comprises:
controlling the output of the gas turbine at a second output value that is greater than a first output value, after a paralleling of a power generator of the gas turbine, the first output value being a gas turbine output when an exhaust gas temperature of the gas turbine falls within a temperature range that is determined based on a metal temperature of the steam turbine; and
controlling the output of the gas turbine at the first output value, in a case where a temperature of the steam generated by the heat recovery steam generator exceeds a temperature based on the metal temperature.
